(19) United States
(12) Patent Application Publication
(10) Pub. No.: US 2008/0181196 A1
(43) Pub. Date: Jul. 31, 2008

(54) Link aggregation across multiple chassis

(75) Inventors: Joseph M. Regan, Pleasanton, CA (US); Ron E. Haberman, San Jose, CA (US); Miroslav Vrana, Zumikon (CH)

Correspondence Address: VAN PELT, YI & JAMES, LLP AND ALCATEL, 10050 N. FOOTHILL BLVD., SUITE 200, CUPERTINO, CA, 95014, US

(73) Assignee: Alcatel Lucent

(21) Appl. No.: 11/712,591

(22) Filed: Feb. 27, 2007

Related U.S. Application Data
(60) Provisional application No. 60/898,781, filed on Jan. 31, 2007.

(51) Int. Cl. H04L 12/28

(52) U.S. Cl. 370/351; 370/389

(57) ABSTRACT

Aggregating links across multiple chassis is disclosed. An indication that one or more local links are to be aggregated with one or more links on another chassis is received. Coordination with the other chassis is performed, via an inter-chassis control path, to present to a downstream equipment as an aggregated group of links the one or more local links and the one or more links on the other chassis.

### CROSS REFERENCE TO OTHER APPLICATIONS

This application claims priority to U.S. Provisional Patent Application No. ______(Attorney Docket No. ALCAP031+) entitled LINK AGGREGATION ACROSS MULTIPLE CHASSIS, filed Jan. 31, 2007 which is incorporated herein by reference for all purposes.

### BACKGROUND OF THE INVENTION

Link aggregation has been used to increase bandwidth and/or provide redundancy. In some cases, multiple Ethernet links/ports have been aggregated into a group and presented to another node as a single logical entity. The term “link aggregation group” (LAG) has been used to describe a group of links presented as a single logical entity. The link aggregation control protocol (LACP) has been defined to facilitate establishment and control of a group of aggregated links (e.g., LAG).

Typically, link aggregation has been applied to the links of a single computer chassis. However, such an approach does not provide redundancy in the event of failure of an entire chassis and/or all LAG-associated links on a chassis. Therefore, there is a need for a way to provide the benefits of link aggregation in a multi-chassis environment.

### BRIEF DESCRIPTION OF THE DRAWINGS

Various embodiments of the invention are disclosed in the following detailed description and the accompanying drawings.

FIG. 1 is a block diagram illustrating an embodiment of a prior art link aggregation group (LAG).

FIG. 2 is a block diagram illustrating an embodiment of a prior art link aggregation group (LAG).

FIG. 3 is a block diagram illustrating an embodiment of a system for aggregating links across multiple chassis.

FIG. 4 is a flow chart illustrating an embodiment of a process for aggregating links across multiple chassis.

FIG. 5 is a flow chart illustrating an embodiment of a process for aggregating links across multiple chassis.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Link aggregation across multiple chassis is disclosed. In some embodiments, one or more links across two or more chassis, such as two or more provider edge service switches or routers, are aggregated and presented to a downstream equipment, such as a DSLAM or other customer premises equipment (CPE) as a single logical entity, such as a link aggregation group (LAG). In some embodiments, coordination is achieved at least in part via inter-chassis communication via an IP or other control path. A common LAG or other identifier to be presented to the downstream equipment is negotiated in some embodiments, for example, via such a control path. In some embodiments, the chassis coordinate to set a first priority within the LAG of a first set of one or more links on a first chassis to a level higher or lower than a second priority within the LAG of a second set of one or more links on a second chassis, depending on whether the first chassis or the second chassis is in the active or standby state, e.g., to ensure that the downstream equipment sends only traffic only to the active chassis, thereby enabling service-based accounting, enforcement of service-based obligations and/or policies (e.g., service level agreements, quality of service commitments, etc.) to be fulfilled and/or enforced.

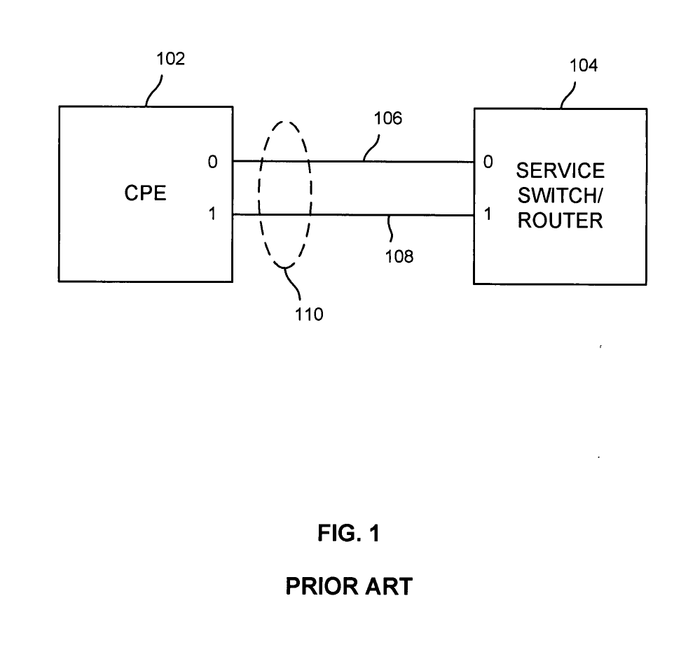

FIG. 1 is a block diagram illustrating an embodiment of a prior art link aggregation group (LAG). In the example shown, a customer premises equipment (CPE) 102 is connected to a service switch/router 104 via a first link 106 and a second link 108. The links have been aggregated to form a link aggregation group 110, which is presented to the CPE 102 as a single logical entity. For example, in some embodiments a MAC client on CPE 102 would see the LAG 110, and associated ports “0” and “1”, as a single logical connection to switch/router 104. To send traffic to switch/router 104, the MAC client on CPE 102 would use a MAC address associated with LAG 110. An aggregator and/or other process or module on CPE 102 would receive outgoing traffic addressed to the MAC address associated with the LAG 110, and would direct it to an appropriate one of ports “0” and “1” to be sent to switch/router 104 via a corresponding one of links 106 and 108. The operation of an aggregator, the manner in which a port/link is selected from within a LAG, etc. in the context of aggregation of links to a single chassis are well known to those of ordinary skill in the art.

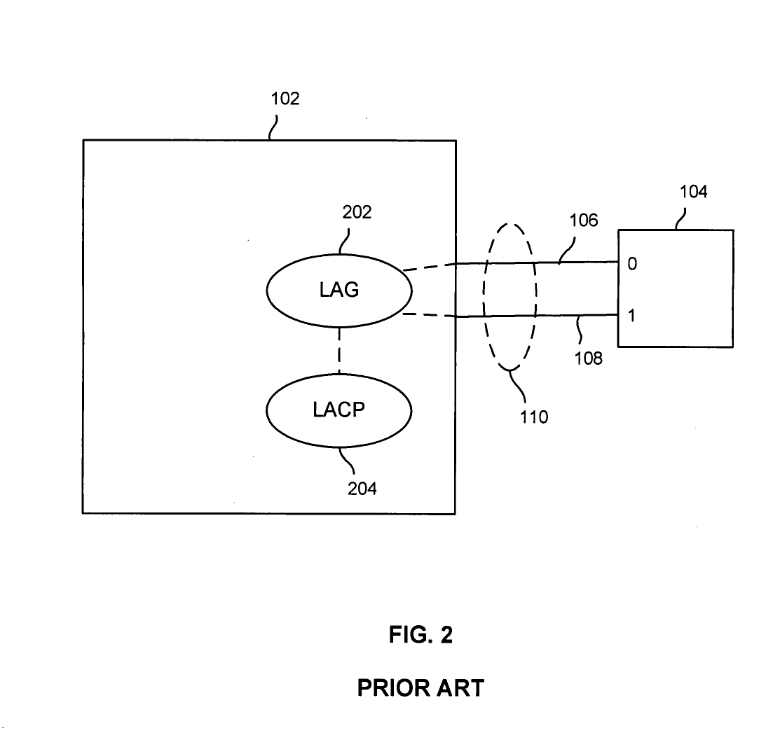

FIG. 2 is a block diagram illustrating an embodiment of a prior art link aggregation group (LAG). In the example shown, the CPE 102 is shown to include a LAG instance 202, which in various embodiments is configured to present the links 106 and 108 to the CPE 102 as a single logical entity. In various embodiments, the LAG instance 202 distributes to corresponding and/or appropriate links in the group outgoing frames addressed by a local MAC client to a MAC address associated with the LAG and/or collects and forwards to the local MAC client frames received via links comprising the LAG. A link aggregation control protocol (LACP) instance 204 is associated with the LAG instance 202 in the example shown. LACP instance 204 is configured in some embodiments to facilitate establishment and control of the LAG, e.g., by communicating with a LACP instance on the far end system, via control frames sent via links comprising the LAG, to negotiate and/or report LAG parameters, etc.

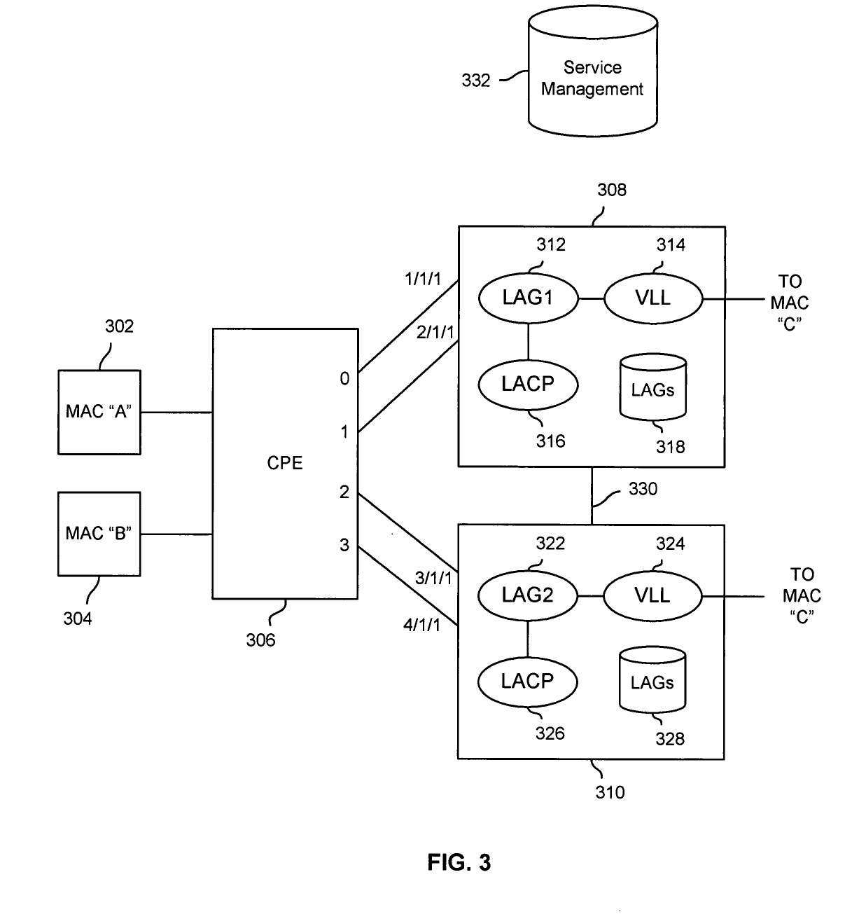

FIG. 3 is a block diagram illustrating an embodiment of a system for aggregating links across multiple chassis. In the example shown, subscriber hosts 302 and 304 access network services via a customer premises equipment (CPE) 306, such as a DSLAM. CPE 306 is connected to a service provider's network via local ports 0-3. In the example shown, ports 0 and 1 of CPE 306 are connected via corresponding links to ports 1/1/1 and 2/1/1, respectively, of a first provider edge service switch/router 308. Likewise, ports 2 and 3 of CPE 306 are connected via corresponding links to ports 3/1/1 and 4/1/1, respectively, of a second provider edge service switch/router 310. The links associated with ports 0-3 on CPE 306 are presented to CPE 306 as a single logical entity, e.g., a single LAG. In the example shown, the subscriber hosts downstream of CPE 306, i.e., hosts 302 and 304, have connectivity to a remote host having MAC address “C” (not shown) via the CPE 306, e.g., via an associated network service. Each of the switches/routers 308 and 310 has a virtual leased line (VLL) (314 and 324, respectively) configured to transport network traffic between the remote host having MAC address “C” (not shown) and the subscriber hosts (302, 304) downstream of CPE 306. In this example, the respective links to ports 1/1/1 and 2/1/1 on switch/router 308 and to ports 3/1/1 and 4/1/1 on switch/router 310 are aggregated and presented to CPE 306 as a single logical entity, e.g. a single LAG, having an associated MAC address to which Ethernet frames may be addressed as a destination and sent via any one of the links in the group. LAG functionality is provided with respect to the links to switch/router 308 by a LAG instance 312, which is configured to forward to VLL instance 314 frames that are received on either port 1/1/1 or port 2/1/1 and addressed to the LAG MAC address, and to send to CPE 306 via an appropriate one of ports 1/1/1 and 2/1/1 frames received via VLL instance 314 that are addressed to a destination for which the next hop is determined at switch/router 308 to be a MAC address with which the ports 0 and 1 on CPE 306 are associated. LAG functionality is established between CPE 306 and switch/router 308, and subsequently coordinated and controlled, by a LACP instance 316 associated with LAG instance 312. Switch/router 310 likewise has a corresponding LAG instance 322 and LACP instance 326.

Link aggregation is coordinated across chassis, e.g., between the switch/router 308 and the switch/router 310 in the example shown in FIG. 3, by communications sent between the chassis, e.g., via an IP or other control path. In the example shown in FIG. 3, an IP control path 330 is used by switches/routers 308 and 310 to coordinate aggregation of their respective links to CPE 306. In some embodiments, the LAG instance 312 on switch/router 308 coordinates with the LAG instance 322 on switch/router 310, e.g., to negotiate a LAG identifier to be used to identified the links aggregated across the chassis, select a MAC address to be associated with the cross-chassis LAG and its component links, and set the respective priorities of the links comprising the cross-chassis LAG. In the example shown, each switch/router uses a local LAG information data store (318, 328) to store information used to establish and control cross-chassis LAGs, such as by storing an identification of another chassis and/or its links included in a LAG, a LAG identifier associated with the LAG, and rules and/or values for setting the priority for local links included in a cross-chassis LAG.

In some embodiments, it may be desirable to have all traffic associated with a particular network service, e.g., a VPRN, VLL, or other service, be sent through a particular node. For example, it may be desired that all traffic pass through a primary or “active” node responsible at a given point in time for performing accounting functions (e.g., based on the number and/or size of frames sent/received, time of day, etc.) and/or to enforce policies and/or service level and/or quality of service agreements or other obligations. In some embodiments, policies and other requirements to be enforced with respect to traffic associated with a particular service and/or subscriber are stored in a service management data store 332, which is accessed and/or otherwise used by a currently “active” one of the switches/routers 308 and 310 to configure and provide the service.

In some embodiments, one of switches/routers 308 and 310 is configured to be in an “active” status and the other to be in a “standby” status with respect to a service with which the multi-chassis LAG illustrated in FIG. 3 is associated. The switches/routers 308 and 310 coordinate, using communications exchanged via control path 330, to ensure that the CPE 306 sends only to the active one of switches/routers 308 and 310 traffic associated with the service with respect to which the active one is active. Normally, the CPE 306 would send traffic associated with a service associated with the LAG illustrated in FIG. 3 via any appropriate one of the four links comprising the LAG, since all would be associated at the CPE 306 with the same logical entity at the far end, i.e., the MAC address used in common by the links of the LAG. To cause the downstream node to instead send traffic only via the links to an active one of the multiple chassis having links included in a multi-chassis LAG, in some embodiments the chassis coordinate via a control path, such as IP control path 330 in FIG. 3, to set the priority of the links to a standby chassis to be sufficiently lower than the priority of links to an active chassis such that traffic is sent only via the links to the active chassis. The links to the standby chassis remain active, but unused due to their lower priority, such that upon failure of the active node or the links thereto the downstream node (CPE 306 in this example) would seamlessly, due to normal LAG operation, shift to sending traffic via the links to the standby node.

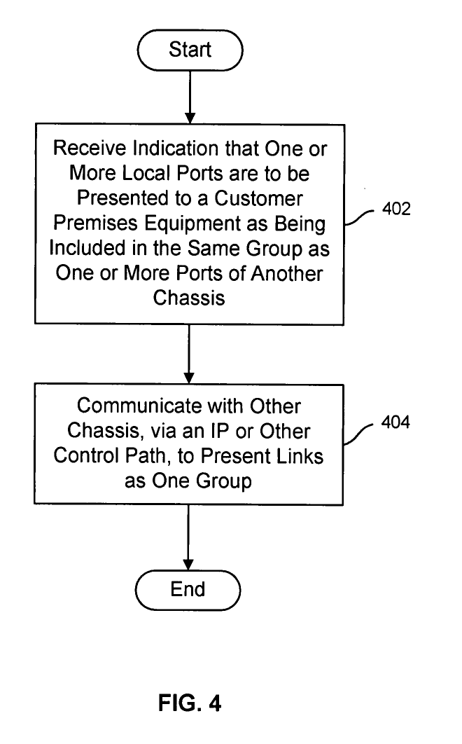

FIG. 4 is a flow chart illustrating an embodiment of a process for aggregating links across multiple chassis. In the example shown, an indication is received that one or more local ports are to be presented to a downstream equipment, e.g., a customer premises equipment, as being included in the same group as one or more ports of another chassis (402). The other chassis is communicated with via an IP or other control path to coordinate and control presenting the links of the two (or more) chassis to the downstream node as a single logical entity, e.g., as a single LAG.

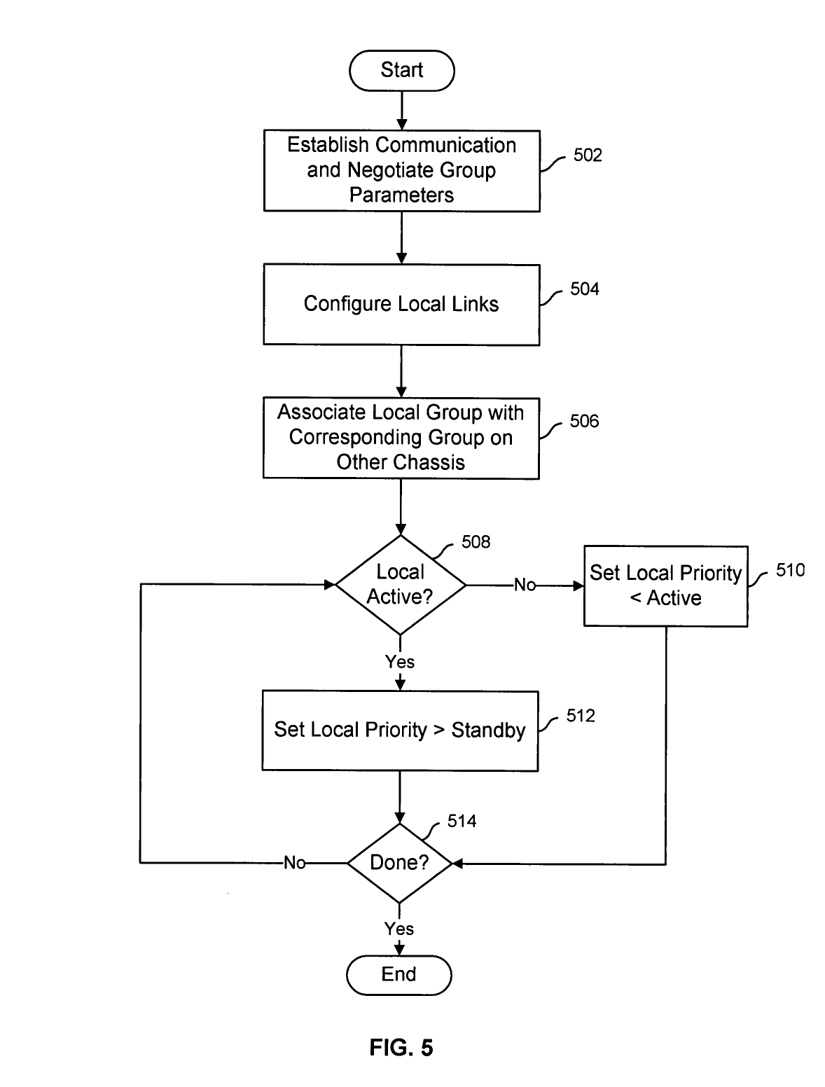

FIG. 5 is a flow chart illustrating an embodiment of a process for aggregating links across multiple chassis. In some embodiments, 404 of FIG. 4 includes the process of FIG. 5. In the example shown, communication with the other chassis that is to have one or more links included in a cross-chassis group is established, and group parameters (e.g., LAG identifier, group MAC address, etc.) are negotiated (502). In some embodiments, communication is established and parameters negotiated via an IP or other control path, such as control path 330 of FIG. 3. One or more local links to be included in the cross-chassis group are configured (504). In various embodiments, configuring one or more local links includes instantiating and associating with the links a LAG instance configured to present the one or more local links as a single logical entity. The local group with which the local links are associated is associated with a corresponding group on the other chassis (506). In some embodiments, associating a local link group with a corresponding group on another chassis includes storing in a local cross-chassis LAG store, such as data stores 318 and 328 of FIG. 3, data associating the local group with the corresponding group on the other chassis.

If the local links are indicated as being the standby links for a service with which the multi-chassis LAG is associated (508), the priority (in the context of the multi-chassis LAG) of the local links is set to a level sufficiently lower than the priority of the corresponding links of the other chassis to ensure that the downstream node sends traffic only to the active link(s)/chassis (510). Conversely, if the local links are indicated as being the active links for the service (508), the priority of the local links is set to a level sufficiently higher than the priority of the corresponding links of the other chassis to ensure that the downstream node sends traffic only to the local link(s) (512). In various embodiments, the priority level to which links are set to be in the active or standby state, respectively, is predetermined, preconfigured, user configurable, and/or determined dynamically by a negotiation or other communication between the chassis, e.g., via an inter-chassis control path. Link priority is set and/or updated, as required, to ensure traffic is sent only to the active chassis (508-512) unless/until the process of FIG. 5 ends (514).

Using the techniques described herein, multi-chassis link aggregation enables redundancy and seamless rollover to a standby chassis to be provided while ensuring that traffic is sent via a designated “active” chassis, to enable service or subscriber based policies and/or other requirements to be enforced.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of aggregating links across multiple chassis, comprising:
receiving an indication that one or more local links are to be aggregated with one or more links on another chassis; and
coordinating with the other chassis, via an inter-chassis control path, to present to a downstream equipment as an aggregated group of links the one or more local links and the one or more links on the other chassis.

2. A method as recited in claim 1, wherein the aggregated group of links comprises a link aggregation group (LAG).

3. A method as recited in claim 1, wherein the links comprise Ethernet links.

4. A method as recited in claim 1, wherein the one or more local links are associated with a local chassis.

5. A method as recited in claim 1, wherein the inter-chassis control path comprises an IP control path.

6. A method as recited in claim 1, wherein coordinating includes determining a group identifier to be associated with the aggregated group of links.

7. A method as recited in claim 1, wherein coordinating includes determining a MAC or other physical layer address to be associated with the aggregated group of links.

8. A method as recited in claim 1, wherein coordinating includes determining for the one or more local links a link priority within the group for the one or more local links relative to the one or more links of the other chassis.

9. A method as recited in claim 8, wherein the link priority for the local links relative to the links of the other chassis is dynamic.

10. A method as recited in claim 8, wherein the link priority for the local links relative to the links of the other chassis is determined based at least in part by whether the one or more local links are in an active state or a standby state.

11. A method as recited in claim 8, wherein the link priority for the local links relative to the links of the other chassis is determined based at least in part by whether the one or more local links are in an active state or a standby state with respect to a service, a subscriber, or both with which the aggregated group of links

12. A method as recited in claim 1, further comprising storing in a local data store a data associating the one or more local links with the one or more links on the other chassis.

13. A method as recited in claim 12, wherein the data includes data associating a local link aggregation group with which the one or more local links are associated with a remote link aggregation group with which the one or more links on the other chassis are associated.

14. A method as recited in claim 1, further comprising configuring the one or more local links to be presented to the downstream equipment as members of the aggregated group of links.

15. A method as recited in claim 1, wherein the downstream equipment comprises a customer premises equipment.

16. A method as recited in claim 1, wherein the downstream equipment comprises a DSLAM.

17. A method as recited in claim 1, wherein the downstream equipment is configured to send via an appropriate link comprising the aggregated group of links a frame associated with the aggregated group of links.

18. A method as recited in claim 17, wherein the appropriate link is determined based at least in part on a respective priority, within the context of the aggregated group, of the links comprising the aggregated group.

19. A system configured to aggregate links across multiple chassis, comprising:
a communication interface configured to facilitate communication with another chassis via an inter-chassis control path; and
a processor coupled to the communication interface and configured to:
receive an indication that one or more local links are to be aggregated with one or more links on the other chassis; and
coordinate with the other chassis, via the inter-chassis control path, to present to a downstream equipment as an aggregated group of links the one or more local links and the one or more links on the other chassis.

20. A computer program product for aggregating links across multiple chassis, the computer program product being embodied in a computer readable medium and comprising computer instructions for:
receiving an indication that one or more local links are to be aggregated with one or more links on another chassis; and
coordinating with the other chassis, via an inter-chassis control path, to present to a downstream equipment as an aggregated group of links the one or more local links and the one or more links on the other chassis.
